(19) United States
(12) Patent Application Publication
(10) Pub. No.: US 2009/0166317 A1
(43) Pub. Date: Jul. 2, 2009

(54) METHOD OF PROCESSING SUBSTRATE BY IMPRINTING

(75) Inventors: Shingo Okushima, Tokyo (JP); Atsunori Terasaki, Kawasaki-shi (JP); Junichi Seki, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/337,155

(22) Filed: Dec. 17, 2008

(30) Foreign Application Priority Data
Dec. 26, 2007 (JP) 2007-334646

(51) Int. Cl. C03C 15/00

(52) U.S. Cl. 216/11

(57) ABSTRACT

A method of processing a substrate includes applying a resin on the substrate, imprinting a pattern of a mold onto the resin, the pattern including protrusions and recesses, forming a protective layer over the resin, etching the protective layer so that the protrusions of the pattern imprinted in the resin are exposed and the protective layer in the recesses of the pattern in the resin remains, etching the exposed protrusions of the pattern, to expose the substrate, while using the protective layer as a mask to prevent areas covered by the protective layer from being etched, so that a reverse pattern is formed on the protective layer, which has a structure reversed from the pattern imprinted on the resin, and etching the exposed substrate, to etch a pattern in the substrate, while using the reverse pattern as a mask to prevent areas covered by the protective layer from being etched.

### BACKGROUND OF THE INVENTION

1. Field of the Invention

The present invention relates to a method of processing a substrate by an imprinting technique, including transferring a pattern on a mold onto a resin layer.

2. Description of the Related Art

Recently, a fine processing technology enabling transfer of a fine structure on a mold onto a workpiece composed of metal, resin, or the like, has been developed and gained much attention (refer to Stephan Y. Chou et. al., Appl. Phys. Lett., vol. 67, issue 21, pp. 3114-3116 (1995)). This technology is also known as “nano-imprinting” or “nano-embossing” and offers a resolution on the order of several nanometers. Thus, there are rising expectations that the technology will be a next-generation semiconductor fabrication technology that replaces the optical exposure machines such as steppers, scanners, etc. Moreover, since the technology enables wafer-level processing of three-dimensional structures, it is expected to be applied to a wide variety of areas including fabrication of optical elements, such as photonic crystals, biochip fabrication technology such as micro total analysis systems (μ-TAS), etc.

In the case wherein the fine processing technology is applied to semiconductor fabrication technology, for example, the process proceeds as follows: A work constituted by a substrate (e.g., a semiconductor wafer) and a photocurable resin layer on the substrate is aligned with a mold on which a desired protrusion/recess pattern is formed. The gap between the mold and the work is filled with a resin, and the resin is cured by irradiation with ultraviolet light. As a result, the pattern is transferred onto the resin layer. Etching, or the like, is then performed by using the resin layer as a mask layer to form the pattern on the substrate.

Among various techniques of imprinting, a step-and-repeat technique is known as a technique suitable for semiconductor lithography, by which patterns are sequentially transferred onto a substrate by using a template smaller than the substrate in size (refer to the specification of U.S. Pat. No. 7,077,992). According to this technique, which uses a template smaller than the substrate in size, the accumulative errors that would occur during pattern drawing due to use of a larger template can be suppressed, and the cost for fabricating the template can be reduced.

A drop-on-demand technique is known as a method of forming a resin layer suitable for the step-and-repeat technique (refer to the specification of United States Patent Application No. 2005/0270312) by which a resin is applied each time a shot is made. According to this technique, the amount of resin to be applied can be locally controlled according to the shape and density of the pattern of the mold, the thickness of the resin layer can be made uniform during imprinting, and the transfer accuracy can be enhanced.

In forming a pattern on a substrate by the step-and-repeat imprinting described above, the following difficulties arise. That is, adjacent resin layers formed by shots interfere with each other. Thus, the accuracy of connecting adjacent shot patterns is affected by the overflowing resin and the processing accuracy of the mold wall surface. This problem is described below by taking an example of forming a periodic dot pattern by imprinting in which the drop-on-demand technique is used to apply a resin. Referring to FIG. 12A, resin layers 204 are respectively formed by imprinting shots. X indicates the periodic distance of the dot pattern and Y indicates the distance between shots. Referring to FIG. 12B, dot patterns 1201 are formed on a substrate by imprint patterning.

In general, it is difficult to form a pattern over the entirety of the mold, including mold edges, during fabrication of the mold. Even if the pattern could be formed on the mold edge portions, it is difficult to optimally control the resin layer at the edge portions of the mold and thus formation of the resin layer 204 outside the mold surface is rarely prevented. This is also because the distance X is on the order of nanometers. As shown in FIG. 12A, the resin layers 204 have excess regions at the edges, and the excess regions may interfere with each other, thereby making it difficult to adjust the distance Y to a desired value.

As a result, the inter-shot distance Y becomes larger than the periodic distance X of the dot patterns, and an optimal periodic structure is rarely formed. This problem is not specific to dot patterns and equally arises in other types of periodic patterns, continuous patterns, such as line-and-space patterns, and free patterns. Moreover, this problem is not specific to the drop-on-demand technique and equally arises when the resin is applied on a substrate in one step. To be more specific, it becomes difficult to adjust the distance between shots to a desired value if the adjacent resin layers interfere with each other, i.e., the adjacent resin layers formed by shots are already cured or a new resin overrides an adjacent resin layer formed in advance. Thus, in applying the step-and-repeat technique to fabrication of a larger device by connecting adjacent shot patterns, this problem needs to be overcome.

Moreover, in order to enhance the degree of freedom of connecting the adjacent shots, step-and-repeat imprinting may be conducted a plurality of times. In such cases, the following problem arises every time imprinting is performed to process the substrate.

That is, during the second substrate processing, there is a risk that the pattern on the substrate formed by the first substrate processing would be etched. As a result, the substrate pattern formed by step-and-repeat imprinting on the substrate may become non-uniform.

### SUMMARY OF THE INVENTION

The present invention provides a substrate processing method by which substrate patterns are uniformly formed for processing the substrate by a step-and-repeat imprinting technique. The present invention also provides a substrate processing method by imprinting that can improve the accuracy of connecting adjacent shot patterns without being affected by the processing accuracy of the mold wall surface or the overflowing resin.

A first aspect of the present invention provides a method of processing a substrate by imprinting, the method including an applying step of applying a resin on at least a portion of the substrate to form a resin layer in a resin layer region, an imprinting step of imprinting a pattern of a mold onto a portion of the resin layer region, the pattern including protrusions and recesses, a protective layer forming step of forming a protective layer over (i) the resin layer region where the pattern is formed, (ii) the resin layer region where the pattern is not formed, and (iii) the substrate where the resin layer is not formed, a protective layer etching step of etching the protective layer so that (i) the protrusions of the pattern imprinted in the portion of the resin layer region are exposed and (ii) the protective layer in the recesses of the pattern in the portion of thee resin layer region remains, a reverse pattern-forming step of etching the exposed protrusions of the pattern, to expose the substrate, while using the protective layer as a mask to prevent areas covered by the protective layer from being etched, so that a reverse pattern is formed on the protective layer, which has a structure reversed from the pattern imprinted on the portion of the resin layer region, and a substrate etching step of etching the exposed substrate, to etch a desired pattern in the exposed substrate, while using the reverse pattern as a mask to prevent areas covered by the protective layer from being etched, wherein the above steps constitute a substrate processing process and the substrate processing process is conducted a plurality of times to process the substrate.

In the imprinting step of the second and subsequent substrate processing processes, the resin layer region is formed on the substrate to at least partially overlap the resin layer region formed in a previous substrate processing process.

The protective layer is formed to satisfy the relationship:

H2>(R2/R1)×H1

where:

H1 is a depth of etching the substrate in said substrate etching step;

H2 is a thickness of the protective layer on the substrate, at the final stage of said reverse pattern-forming step;

R1 is an etching rate of the substrate in said substrate etching step; and

R2 is an etching rate of the mask in said substrate etching step.

The substrate processing process may be conducted twice, and the resin layer region in the applying step of a second substrate processing process and the resin layer region in the applying step of a first substrate processing process at least partially overlap each other in one of (i) a first direction on a plane of the substrate and (ii) a second direction orthogonal to the first direction.

In the imprinting step, a plurality of patterns are formed in a plurality of pattern regions.

The substrate processing process may be conducted three times, in a first substrate processing process, the plurality of pattern regions are arranged in rows so that a space between the adjacent pattern regions in each row, in a first direction on a plane of the substrate, is twice the width of the pattern region in the first direction and a distance between a center of each adjacent row in a second direction, orthogonal to the first direction, is the width of the pattern region in the second direction, wherein the pattern regions in the second direction are arranged to not be in contact with each other, in a second substrate processing process, the plurality of pattern regions are each arranged in regions adjacent to one side of the pattern regions formed in the first substrate processing process in the first direction, and in a third substrate processing process, the plurality of pattern regions in which patterns are formed are each arranged in regions adjacent to the pattern regions formed in the second substrate processing process and adjacent to another side of the pattern regions formed in the first substrate processing process in the first direction.

The substrate processing process may be conducted four times, in a first substrate processing process, the plurality of pattern regions in which patterns are formed are arranged so that a space between the pattern regions, in a first direction on a plane of the substrate, is equal to the width of the pattern region in the first direction and a distance between the pattern regions in a second direction, orthogonal to the first direction, is equal to the width of the pattern region in the second direction, in a second substrate processing process, the plurality of pattern regions are arranged in regions adjacent to the pattern regions formed in the first substrate processing process in the first direction, in a third substrate processing process, the plurality of pattern regions are arranged in regions adjacent to the pattern regions formed in the first substrate processing process in the second direction, and in a fourth substrate processing process, the plurality of pattern regions are arranged adjacent to the pattern regions formed in the second substrate processing process in the second direction.

The pattern includes an extended pattern to form a connecting region so that the connecting region in a substrate processing process overlaps adjacent patterns from other substrate processing processes.

An etching selectivity ratio of a material of the resin layer to a material of the protective layer is at least five.

A second aspect of the invention provides a method of processing a substrate, the method including a step of providing a substrate having a first pattern formed on a portion of the substrate, a step of forming a resin layer at least on a portion of the substrate where the first pattern is not formed, a step of forming a pattern of a mold on a portion of the resin layer, the pattern being a second pattern, which includes protrusions and recesses, a step of forming a protective layer on the first pattern and at least the portion of the resin layer where the second pattern is formed, a step of etching the protective layer so that the protrusions of the second pattern are exposed and the protective layer in the recesses of the second pattern in the resin layer remains, a step of forming a reverse pattern, by etching the exposed protrusions of the pattern, to expose the substrate, while using the protective layer as a mask to prevent areas covered by the protective layer from being etched, so that the reverse pattern is formed on the protective layer having a structure reversed from the pattern imprinted on the portion of the resin layer, and a step of processing the exposed substrate, to process a desired pattern into the exposed substrate, while using the reverse pattern as a mask to prevent areas covered by the protective layer from being processed.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a flow chart showing the steps of imprinting according to Example 1.

FIGS. 2A to 2D are cross-sectional views illustrating the imprinting step of Example 1.

FIGS. 3A to 3C are cross-sectional views illustrating a method forming a resin layer in the imprinting step of Example 1.

FIGS. 4A to 4E are cross-sectional views illustrating a protective layer-forming step, a reverse pattern-forming step, and a substrate etching step of Example 1.

FIG. 5 is a cross-sectional view illustrating the shape of a protective layer formed in the protective layer-forming step and the reverse pattern-forming step in Example 1.

FIGS. 6A to 6C are cross-sectional views illustrating formation of the protective layer in the protective layer-forming step and the reverse pattern-forming step of Example 1.

FIGS. 7A to 7F are diagrams illustrating a specific example of connecting patterns through repeated substrate processing processes according to Example 1.

FIGS. 8A and 8B are diagrams illustrating the overlap between the resin layer regions shown in FIGS. 7B and 7E according to Example 1.

FIGS. 9A to 9C are plan views for illustrating arrangement of pattern regions in each imprinting step in the method of conducting a substrate processing process of Example 1 three times.

FIGS. 10A to 10D are diagrams illustrating the imprinting steps of Example 2.

FIGS. 11A and 11B are diagrams illustrating the imprinting steps of Example 3.

FIGS. 12A and 12B are diagrams illustrating imprinting of periodic dot patterns.

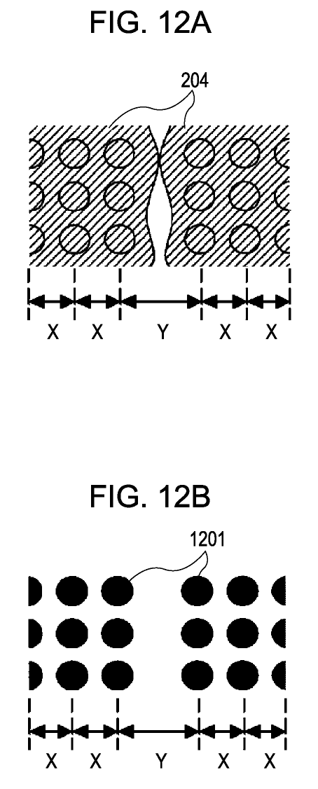

FIGS. 13A to 13D are cross-sectional views illustrating one embodiment.

FIGS. 14A to 14C are cross-sectional views illustrating one embodiment.

### DESCRIPTION OF THE EMBODIMENTS

Embodiments of the present invention will now be described in detail in accordance with the accompanying drawings.

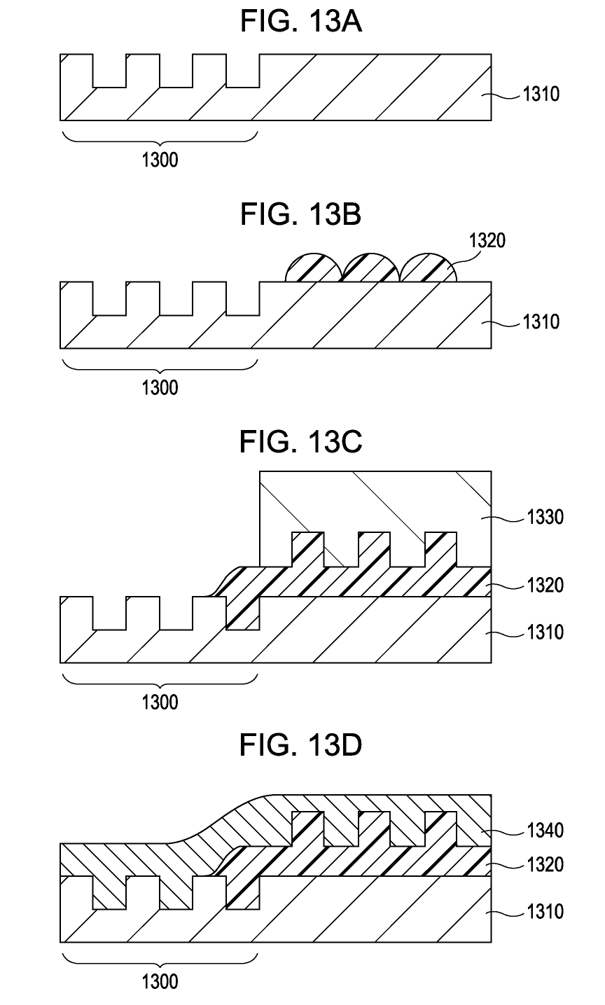

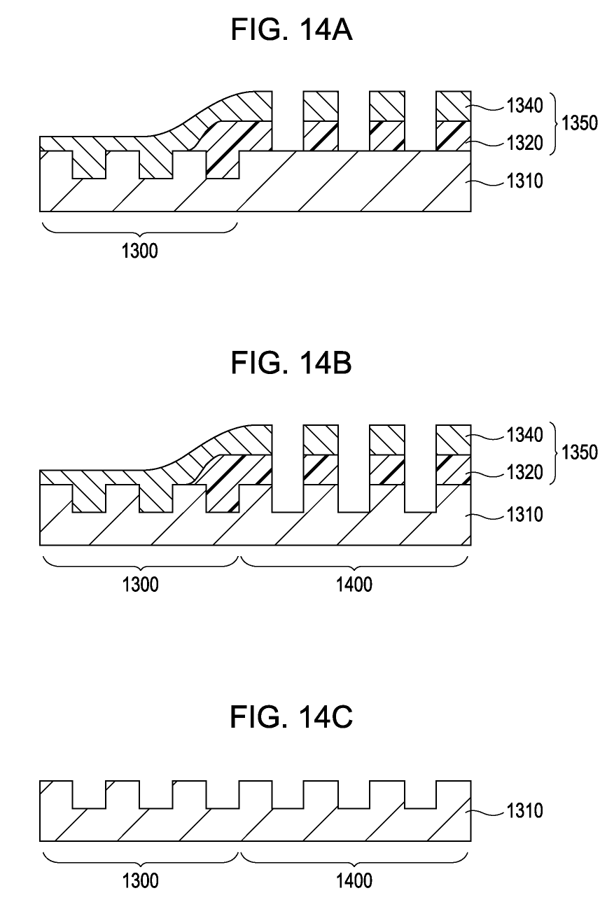

First, an embodiment of the present invention is generally described with reference to FIGS. 13A to 14C.

A substrate 1310, having a first pattern 1300 including protrusions and recesses, is prepared (FIG. 13A). The substrate 1310 is not limited to a substrate prepared by imprinting and may be a substrate having a pattern formed by other substrate processing methods, such as lithography, using an optical exposure machine, or the like. The substrate processing by drop-on-demand imprinting will be described in detail in Example 1 below. The substrate 1310 is not limited to a substrate composed of one material, such as a silicon wafer, and may be a substrate having a multilayer structure formed on a surface.

Next, as shown in FIG. 13B, a resin layer 1320 is formed at least on a part of the substrate 1310 where no first pattern 1300 is provided so that a second pattern can be formed adjacent to the first pattern 1300. The resin layer 1320 may overlap part of the first pattern 1300.

Next, as shown in FIG. 13C, a mold 1330 is aligned with the resin layer 1320 so as to fill the space between the substrate 1310 and the mold 1330 with the resin layer 1320 and transfer the imprint pattern on the mold 1330 onto the resin layer 1320.

As shown in FIG. 13D, a protective layer 1340 is formed on the resin layer 1320. In this step, the protective layer 1340 is also formed by application, or the like, on part of the first pattern 1300 not covered by the resin layer 1320. Next, the protective layer 1340 is etched until the surface of each protrusion formed in the resin layer 1320 is exposed, and then the resin layer 1320 is etched using the protective layer 1340 as a mask, as shown in FIG. 14A. As a result, a reverse pattern 1350 having protrusions and recesses opposite of those of the pattern formed in the resin layer 1320 by the step in FIG. 13C is formed. The reverse pattern 1350 on the substrate 1310 is constituted by part of the protective layer 1340 and part of the resin layer 1320. Next, as shown in FIG. 14B, the substrate 1310 is etched by using the reverse pattern 1350 as a mask. Lastly, the protective layer 1340 and the resin layer 1320 are removed as shown in FIG. 14C.

According to the above-described process, a second pattern 1400 is formed and the adjacent patterns formed by separate shots can be connected to each other. In this embodiment, since the protective layer 1340 is formed on the first pattern 1300 also, the first pattern 1300 is protected during the steps of etching the resin layer and the substrate. Thus, the patterns formed on the substrate become more uniform.

### EXAMPLES

Specific examples of the embodiment will now be described with reference to the drawings. In the drawings for describing the examples, like or corresponding components are represented by the same reference numerals or symbols.

### Example 1

In Example 1, an imprinting method is described. As described earlier, the accuracy of pattern transfer can be improved by employing a drop-on-demand technique for forming the resin layer. Thus, in this example, a method employing the drop-on-demand technique is described.

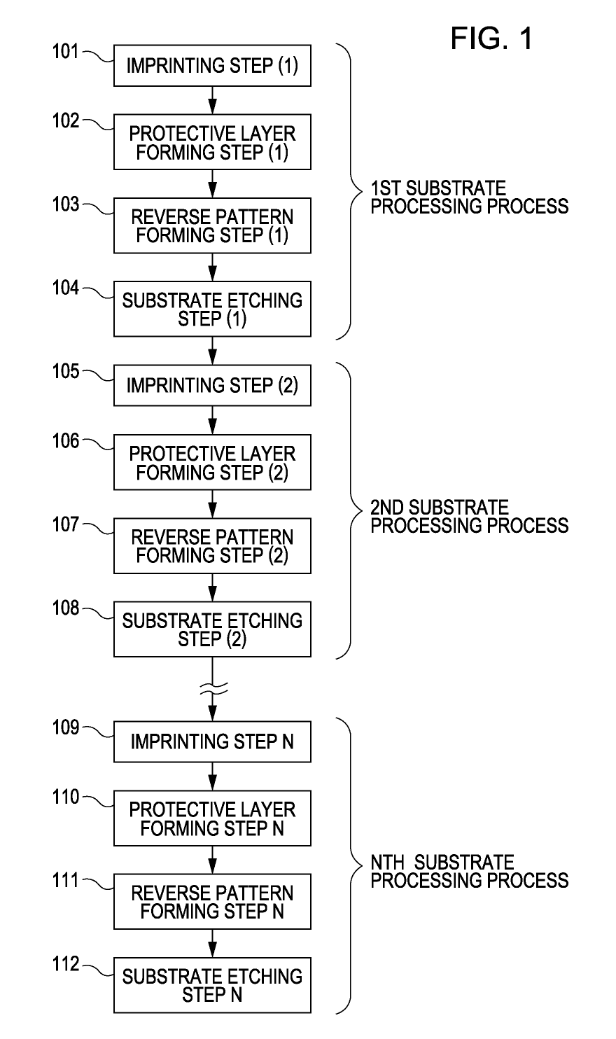

FIG. 1 is a flowchart for explaining the individual steps of the imprinting method of this example. Step 101 is a first imprinting step. In this method, an imprinting operation for transferring a pattern of the mold onto a resin applied on a substrate is performed one or more times by a step-and-repeat technique so as to form a resin layer having patterns transferred thereto. A region where the resin layer is formed in the imprinting step is referred to as “resin layer region”. A region in the resin layer region where an effective pattern lies is referred to as a “pattern region”. The term “effective pattern” refers to a pattern that exist on the substrate at the last stage of the process after all the steps are completed. In other words, the resin layer region includes a region that comes into contact with edges of the mold and where no effective pattern is formed, and a region where the resin overflows from the mold edges.

Step 102 is a first protective layer-forming step. In step 102, a protective material having an etching selectivity ratio for the resin layer is used to bury the pattern formed in the resin layer. Meanwhile, a protective layer composed of the protective material is formed to protect the region on the substrate where no resin layer is formed.

Step 103 is a first reverse pattern-forming step. In step 103, the protective layer is removed until the surface of each protrusion of the resin layer is exposed, and then, the resin layer is etched by using the protective layer buried in the recesses of the resin layer as a mask. In this manner, a reverse pattern, constituted by part of the protective layer and part of the resin layer, is formed on the substrate.

Step 104 is a first substrate etching step. In this step, the reverse pattern is used as a mask to conduct etching so as to transfer the pattern onto the substrate. In step 104, the regions other than the first resin layer region are protected by the protective layer formed in step 103. As a result, a first pattern is formed on the substrate.

As described above, a substrate processing process for forming a pattern on the substrate, according to this example, includes the imprinting step, protective layer-forming step, reverse pattern-forming step, and substrate etching step described above.

Step 105 is a second imprinting step. In step 105, imprinting is conducted so that a resin layer region formed in step 105 overlaps the region where the resin layer has been formed in step 101 so as to connect adjacent shot patterns to each other. That is, in the second and subsequent imprinting steps, a resin layer region is formed to at least partially overlap the resin layer region formed in the previous substrate processing process. Steps 106 to 108 are substantially the same as steps 102 to 104 of the first substrate processing process.

It should be noted that the regions other than the second resin layer region and protected by the protective layer formed in step 107 also include a region where a pattern is already formed on the substrate. In other words, the substrate processing process is conducted without etching the pattern already formed on the substrate.

In this example, imprinting is conducted by bringing the adjacent shot to a position a desired distance away from the already formed pattern. Thus, the adjacent shot pattern regions can be connected to each other without breaks.

Such a substrate processing process is conducted a plurality of times after the second substrate processing process. As shown in FIG. 1, the Nth substrate processing process includes an Nth imprinting step 109, an Nth protective layer-forming step 110, an Nth reverse pattern-forming step 111, and an Nth substrate etching step 112. In this example, the substrate processing process is conducted three times.

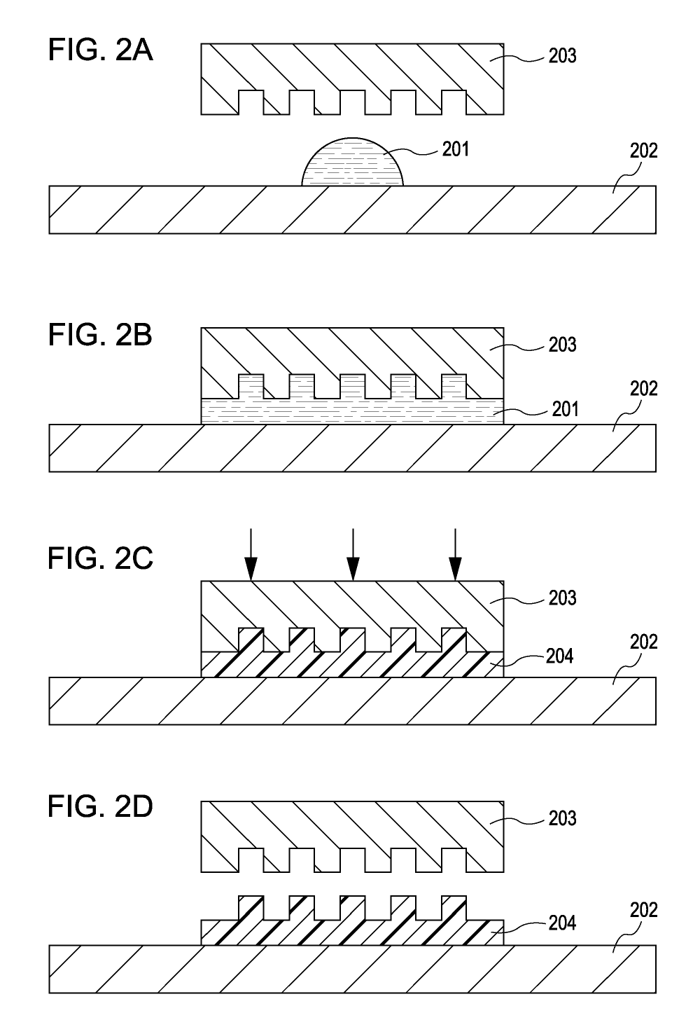

Next, the imprinting step of Example 1 is described specifically. FIGS. 2A to 2D are diagrams illustrating the imprinting step.

In the step shown in FIG. 2A, a resin layer 201 is formed on a substrate 202. Next, in step shown in FIG. 2B, a mold 203 is brought into contact with the resin layer 201 so as to fill the space between the mold 203 and the substrate 202 with the resin layer 201. In step shown in FIG. 2C, the resin layer is cured. In step shown in FIG. 2D, the mold 203 is separated from the cured resin layer 204 so as to transfer the pattern on the mold 203 onto the cured resin layer 204.

In this example, the mold 203 has a desired pattern on its surface and is composed of silicon, quarts, sapphire, or the like. The patterned surface of the mold is usually subjected to releasing treatment with a fluorine-based silane coupling agent, or the like, to form a releasing layer on the surface. In this example, this releasing layer is also considered to be part of the mold.

Examples of the materials of the resin layer 201 include acrylic or epoxy photocurable resins, thermosetting resins, and thermoplastic resins.

The method for forming the resin layer 201 on the substrate 202 may be an ink jet method or a method of applying droplets with a dispenser. One resin layer 201 can be formed per shot in the imprinting process. In this manner, the amount of resin can be locally adjusted according to the pattern density and shape of the mold 203, the thickness of the resin layer 201 during imprinting can be made uniform, and the accuracy of transfer can be improved.

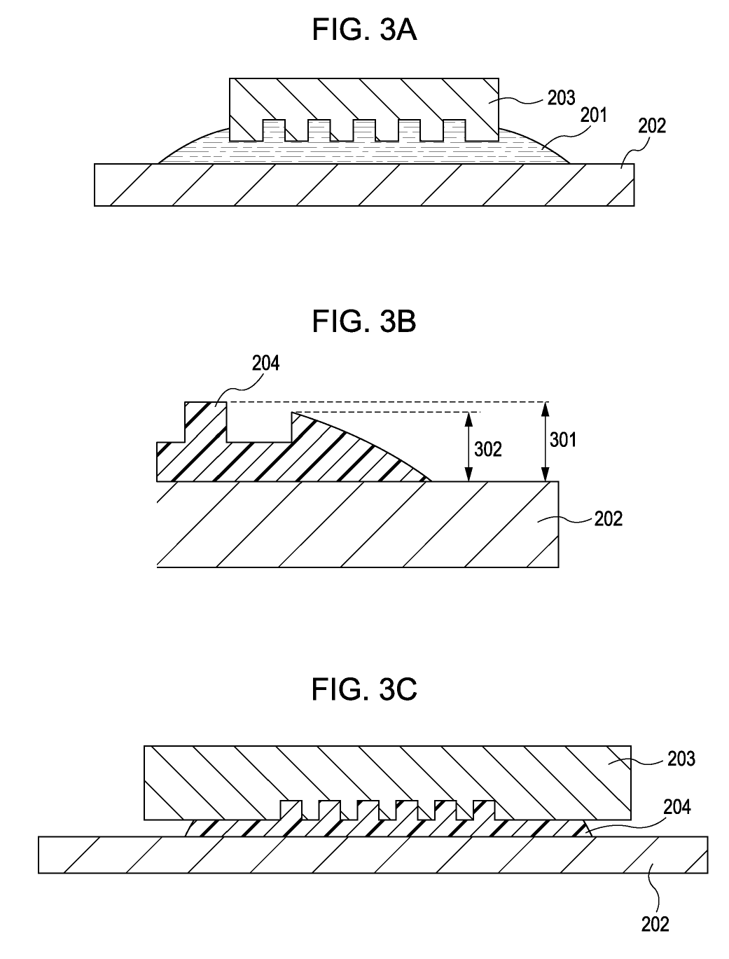

FIGS. 3A to 3C are diagrams illustrating in detail the method of forming the resin layer 201 by the imprinting step in this example. FIG. 3A is a diagram showing the state in which the mold 203 is brought into contact with the resin layer 201 and the space between the mold 203 and the substrate 202 is filled with the resin layer 201. As shown in FIG. 3A, the resin layer 201 is also formed in the regions outside the mold 203. If the thickness of the resin layer 201 outside the mold 203 is large, a desired pattern may not always be formed on the substrate. That is, the cured resin layer 204 is formed so that a distance 302 between the highest point of the resin layer formed in the region outside the mold 203 and the substrate surface is smaller than a distance 301 between the protrusion of the resin layer pattern and the substrate surface.

If the distance 302 is larger than the distance 301, in the subsequent reverse pattern-forming step, the cured resin layer 204 outside the mold 203 becomes exposed before the protrusions on the pattern region are exposed, and as a result, the protective layer may be etched away from the portion that needs to be protected. Thus, in the substrate etching step, regions that are not supposed to be processed may be processed due to an absence of the protective layer. In order to prevent this phenomenon, as shown FIG. 3C, a mold having an area sufficiently larger than the area of the pattern region can be used so that the resin layer 201 does not exist in the regions outside the mold 203 even when the resin layer 201 spreads by filling the gap between the mold 203 and the substrate 202. Because the resin layer 201 is not formed in the regions outside the mold 203, the distance 301 is the maximum distance between the substrate surface and the highest point of the resin layer 201 across the entire region of the cured resin layer 204. Thus, in the substrate etching process, only the desired pattern is processed.

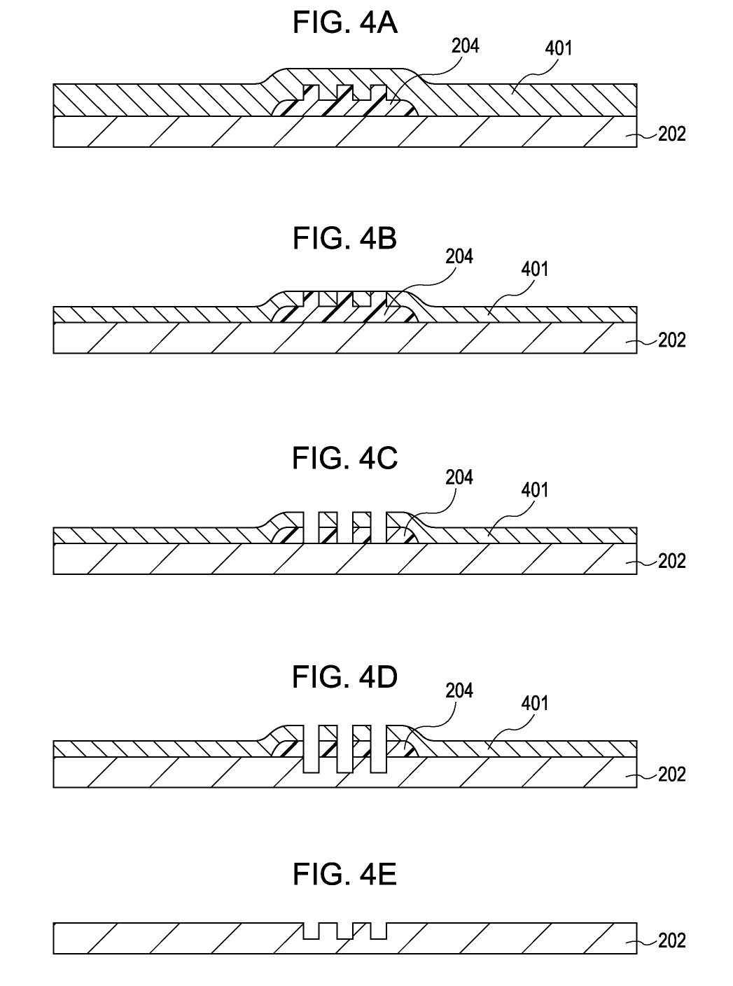

FIGS. 4A to 4E are diagrams illustrating the protective layer-forming step, the reverse pattern-forming step, and the substrate etching step of this example. As shown in FIG. 4A, a protective layer 401 is formed on the substrate 202 and the cured resin layer 204 formed in the imprinting step. During etching of the substrate 202, the protective layer 401 serves as an etching mask for the substrate surface outside the resin layer region and the pattern already formed on the substrate. The protective layer 401 is composed of a material having an etching selectivity ratio for the cured resin layer 204. For example, the protective layer 401 may be composed of a silicon material such as SiO₂, SiN, etc., a silicon-containing resin, or a metal material. Examples of the methods for forming the protective layer 401 include application methods, such as a spin coating method, a dispenser method, an ink jet method, a spray coating method, vapor deposition, such as chemical vapor deposition, and an imprinting method using a flat mold. FIG. 4B shows the state after the state shown in FIG. 4A, in which the protective layer 401 is removed until the protrusions of the cured resin layer 204 are exposed. An example of the method for removing the protective layer 401 is an etch-back method for uniformly etching the entire surface of the protective layer 401. For example, if the protective layer 401 is composed of SiO₂, a fluorocarbon gas such as CF₄, CHF₃, C₂F₆, C₃F₈, C₄F₈, C₅F₈, or C₄F₆ can be used as the gas for etching the protective layer 401. Chemical mechanical polishing is also applicable.

Next, the cured resin layer 204 is etched by using the protective layer 401 buried in the recessed portions of the cured resin layer 204 as a mask. FIG. 4C shows the state after the etching. In other words, a protective layer having a reverse pattern structure in which the imprinted pattern is reversed is formed.

For example, when the protective layer 401 is composed of SiO₂, an O₂-based gas such as O₂, O₂/Ar, or O₂/N2, N₂, H₂, NH₃, or a mixture of three types of gasses can be used as the gas for etching the resin layer 201. In this step, the etching selectivity ratio between the resin layer 201 and the protective layer 401 can be five or more, for example.

Next, the substrate is etched by using the reverse pattern of the protective layer as a mask, the resulting state of which is shown in FIG. 4D. For example, when the substrate is composed of Si and the protective layer is composed of SiO₂, a gas based on one or mixture of Cl₂, HBr, and O₂ can be used. The remaining protective layer 401 and cured resin layer 204 are removed as shown in FIG. 4E. As a result, the desired pattern can be transferred onto the substrate 202. For example, when the substrate 202 is composed of Si and the protective layer 401 is composed of SiO₂, the protective layer 401 may be removed by wet-etching with hydrofluoric acid.

A pattern on a resin layer can be transferred onto a substrate by etching back the entire imprinted resin layer to remove any residual film and to thereby expose the substrate surface; however, this technique does not achieve transfer accuracy as high as the aforementioned process of this example. This is because whereas the edges of the mask become eroded and the shape degraded according to the etching back method, resulting in poor dimension controllability, the shape of the mask edges stay rectangular due to a high etching selectivity ratio between the protective layer 401 and the cured resin layer 204 according to the aforementioned method of this example.

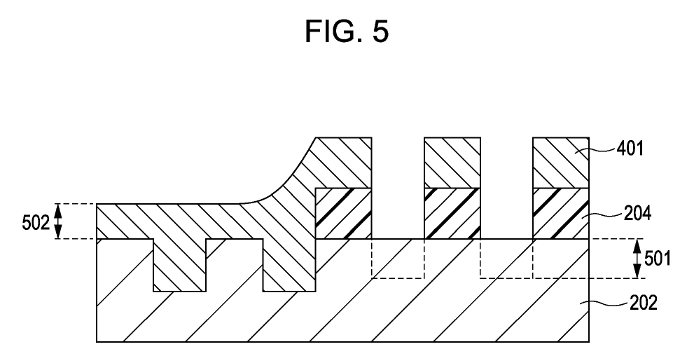

FIG. 5 is a diagram illustrating in detail the shape of the protective layer 401 formed as a result of the protective layer-forming step and the reverse pattern-forming step. FIG. 5 shows the final state at which the reverse pattern is formed in the protective layer 401 in the reverse pattern-forming step.

In order to protect the substrate surface outside the resin layer region and the pattern already formed on the substrate with the protective layer 401 during the substrate etching step, the protective layer 401 needs to be prevented from being completely etched away while the substrate 202 is being etched. This requires that all parts of the protective layer 401 on the regions other than the resin layer region satisfy the conditional expression (1) below:

H2>(R2/R1)×H1 (1)

where H1 is a depth 501 of a substrate to be processed by the substrate etching step, H2 is a thickness 502 of the protective layer 401 in the regions outside the resin layer region (height of the protective layer 401 surface from the substrate surface), R1 is the etching rate of the substrate 202 during the substrate etching step, and R2 is the etching rate of the protective layer 401. For example, suppose that the etching selectivity ratio is ten when the substrate 202 is composed of S1, the protective layer 401 is composed of SiO₂, and the etching gas is based on a mixture of Cl₂, HBr, and O₂. In order to etch the substrate 202 for 1000 nm under these conditions, H2 (the thickness 502) needs to be larger than 100 nm.

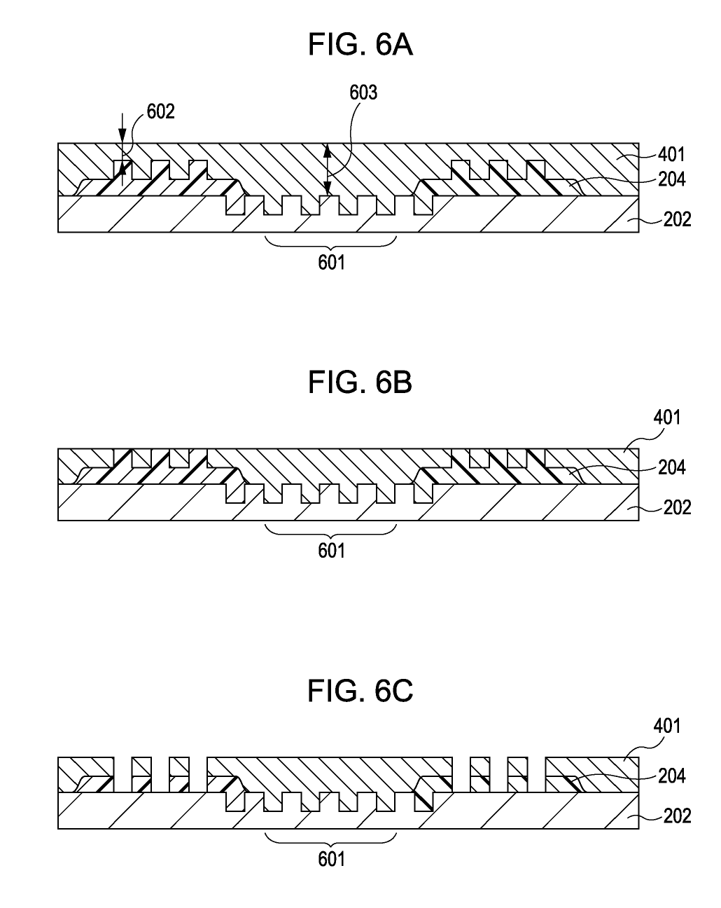

FIGS. 6A to 6C are diagrams illustrating in detail how the protective layer is formed in the protective layer-forming step and the reverse pattern-forming step. As shown in FIG. 6A, no cured resin layer 204 is formed in a region 601. Part of the protective layer 401 on a protrusion of the resin layer pattern has a thickness 602, and part of the protective layer 401 in the region 601 has a thickness 603, as shown in FIG. 6A.

FIG. 6A shows a state after the protective layer 401 is formed on the cured resin layer 204 by a step-and-repeat technique in the imprinting step of this example. FIG. 6B shows a state after the protective layer 401 is etched until the protrusions of the cured resin layer 204 are exposed and FIG. 6C shows a state after the cured resin layer 204 is etched by using the protective layer 401 buried in the recesses in the cured resin layer 204 as a mask. In order for the protective layer 401 to remain on the region 601 at the stage shown in FIG. 6C, the thickness 603 needs to be equal to or more than the thickness 602. Moreover, in order to form a protective layer 401 that satisfies conditional expression (1), the thickness 603 can be larger than the total of the thickness 602 and the thickness H2 of the protective layer 401 formed on the regions other than the resin layer region. In order to achieve this, the surface of the protective layer 401 should be as flat as possible with respect to the substrate surface.

The following methods are applicable as the method for forming the protective layer 401 having a thickness 603 larger than the thickness 602. One is a spin-coating method in which the viscosity of the protective layer material and the contact angle of the protective layer material with respect to the substrate and the resin layer are adjusted. According to the spin-coating method, the surface of the protective layer 401 is made flat and parallel to the substrate surface irrespective of the asperities of the substrate and the resin layer. Another method is an application method in which a dispenser is used or an ink jet technique is employed so that the amount of the protective layer material applied in the region 601 is larger than in other regions. Yet another method is a spray-coating method using a mask so that the amount of the protective layer material in the region 601 is larger than in other regions. Still another method is an imprinting method in which a protective layer composed of a Si-containing resin or the like is imprinted with a flat mold so that the surface of the protective layer is planarized. In order to satisfy conditional expression (1), a chemical mechanical polishing method may be employed to remove the protective layer 401 until the protrusions of the cured resin layer 204 are exposed.

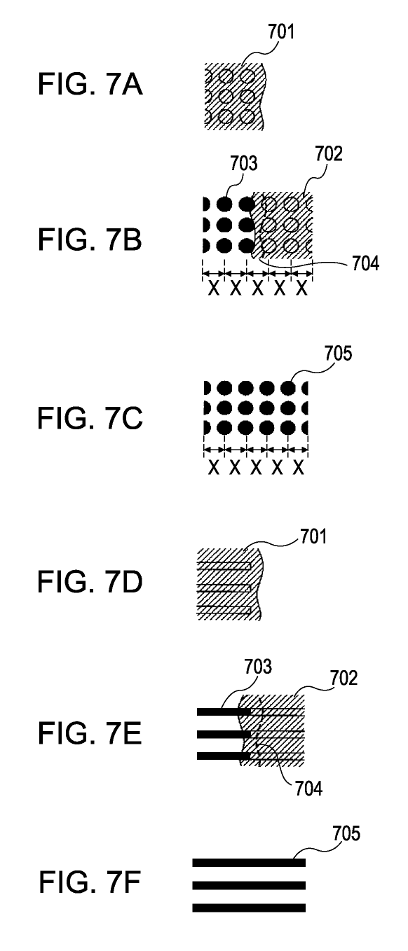

FIGS. 7A to 7F are diagrams illustrating a specific example of connecting patterns through repeated substrate processing processes. FIGS. 7A to 7C show a process of connecting periodic hole patterns. FIG. 7A shows a resin layer 701 formed in the first substrate processing process. After the state shown in FIG. 7A, the hole pattern is formed in the substrate and then a resin layer 702 is formed in the second substrate processing process, as shown in FIG. 7B, next to a pattern 703 formed in the first substrate-processing process. The resin layer 702 formed in the second substrate processing process overlaps the region where the resin layer 701 was formed in the first substrate processing process, as shown by a border line 704 of the region where the resin layer 701 had been formed. Thus, resin layers can be formed by maintaining periodic distance X of the hole patterns. FIG. 7C illustrates a pattern 705 formed by connecting the patterns formed in the first and second substrate processing processes. As described above, by dividing the substrate processing process into two steps, patterns can be processed while maintaining the periodic distances between the hole patterns. Not only the periodic structures but also continuous patterns can be connected.

FIGS. 7D to 7F show a method for connecting line-and-space patterns. The method is similar to the example of forming dot patterns shown in FIGS. 7A to 7C. Examples of the patterns that can be connected include, but are not limited to, hole patterns, free patterns, and various other patterns.

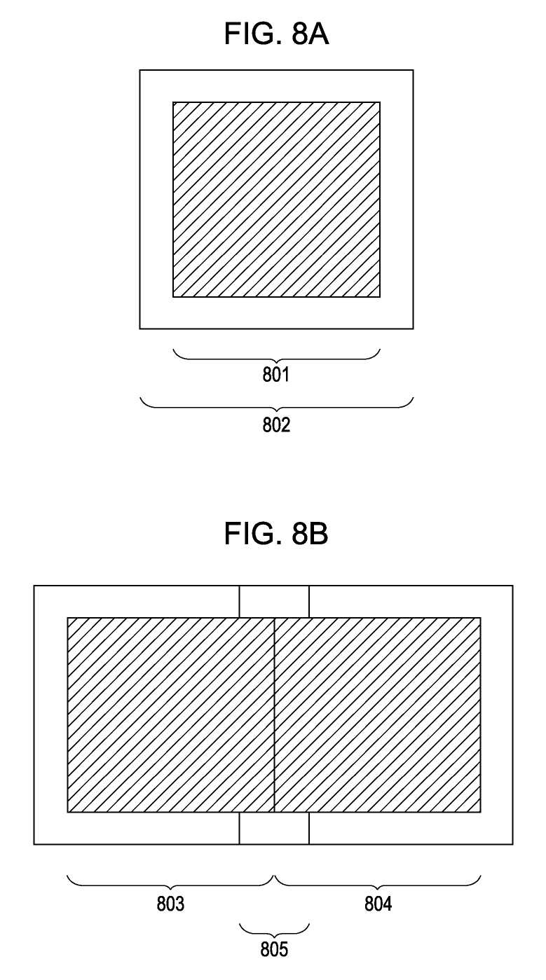

FIGS. 8A and 8B are diagrams illustrating in further detail the overlap between the resin layer regions shown in FIGS. 7B and 7E. FIG. 8A is a diagram illustrating the relationship between a pattern region 801 and a resin layer region 802. As shown in the drawing, the resin layer region 802 is usually larger than the pattern region 801. This is because of the difficulty of forming patterns in edge portions of a mold during preparation of the mold and because sometimes the resin layer spreads out of the mold surface. FIG. 8B is a diagram showing the overlap between a resin layer region in the first substrate processing process, and a resin layer region in the second substrate processing process. As described above, adjacent shots are respectively processed by two substrate processing processes so that the resin layer region of the first substrate processing process overlaps the resin layer region of the second substrate processing process in a region 805. Accordingly, a pattern region 803 of the first substrate processing process and a pattern region 804 of the second substrate processing process can be aligned without any extra space. Alternatively, a method of forming a connecting region outside the pattern region can also be employed. In this connecting region, an extended pattern of the pattern in the pattern region is formed. In other words, the pattern region in the first substrate processing process and the connecting region in the second substrate processing process are arranged to overlap each other. Similarly, the connecting region in the first substrate processing process and the pattern region in the second substrate processing process are arranged to overlap each other. In this manner, the adjacent shot patterns can be more reliably connected. This method is effective in forming continuous patterns, such as lines, or in cases where the alignment accuracy is insufficient.

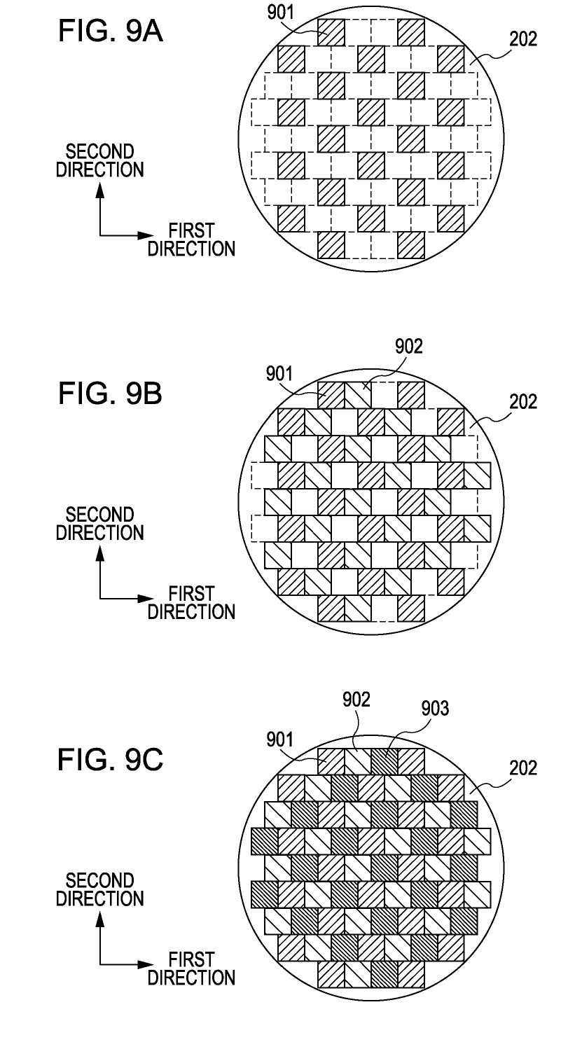

Next, an imprinting method of repeating the substrate processing process three times is specifically described. FIGS. 9A to 9C are plan views of a substrate for describing in detail the arrangement of pattern regions in the respective imprinting steps.

FIG. 9A shows an arrangement of pattern regions 901 in the first substrate processing process. Referring to FIG. 9A, the space between the pattern regions in the first direction aligned in each row is twice the width of the pattern region in the first direction on the plane of the substrate. Between any two adjacent rows, the pattern regions of one row are offset in the first direction by a distance 1.5 times the width of the pattern region in the first direction with respect to the pattern regions of the other row. The distance between the centers of the adjacent rows in the second direction orthogonal to the first direction is equal to the width of the pattern region in the second direction. The distance to be offset in the first direction is not limited to the distance 1.5 times the pattern region width. It can be any distance larger than the pattern region width and smaller than twice the pattern region width. For the purpose of this specification, the phrase “space between the pattern regions in the first direction” means the shortest distance between two pattern regions adjacent to each other in the first direction. In other words, it is the distance from a right end of a left pattern region and a left end of a right pattern region in the first direction. The phrase “width of the pattern region in the first (second) direction” means the length of one side of the pattern region in the first (second) direction.

FIG. 9B shows an arrangement of pattern regions 902 in the second substrate processing process. The pattern regions 902 are arranged to be adjacent to the pattern regions 901 formed in the first substrate processing process relative to the first direction in the drawing. FIG. 9C shows an arrangement of pattern regions 903 in the third substrate processing process. The pattern regions 903 are arranged to be adjacent to the pattern regions 902 formed in the second substrate processing process relative to the first direction in the drawing.

By arranging the pattern regions 901, 902, and 903 in such a manner through conducting the substrate processing process three times as in this example, patterns can be transferred onto the entire substrate. Moreover, the patterns in the pattern regions formed by adjacent shots can be connected to one another. It should be stressed that FIGS. 9A to 9C show only one example, and the number of times the imprinting is conducted in the imprinting step of each substrate processing process and other factors differ depending on the size and shape of the mold and the substrate.

As described above, in Example 1, the adjacent shot patterns can be connected to each other highly accurately. This process is suitable for processing photonic crystals whose structures are periodically arranged in the in-plane direction. The shape of the pattern region of the mold is not limited to rectangular, and may be any of the various shapes such as hexagonal. Although this example employs a drop-on-demand technique in forming the resin layer, the present invention is not limited to the drop-on-demand technique and may be applied to application techniques, such as applying a resin over the entirety of the substrate by spin-coating, or the like. In particular, the spin-coating method can be employed by forming a protective layer that satisfies conditional expression (1) on the resin layers in regions other than the pattern region so that the regions other than the pattern region are prevented from being etched in the substrate etching step.

Although Example 1 involves connecting patterns formed by the substrate processing process by an imprinting technique, the first substrate processing process is not limited to imprinting and other substrate processing techniques can be employed. In other words, a pattern may be formed on a substrate by lithography, with an exposing apparatus or the like, and then the second and subsequent substrate processing processes may be performed so that the pattern formed by lithography is connected to the patterns formed by imprinting.

### Example 2

In Example 2, arrangement of the pattern regions is changed from that in Example 1. Since the second embodiment differs from Example 1 only in the arrangement of the pattern regions, only the arrangement of the pattern regions is described below.

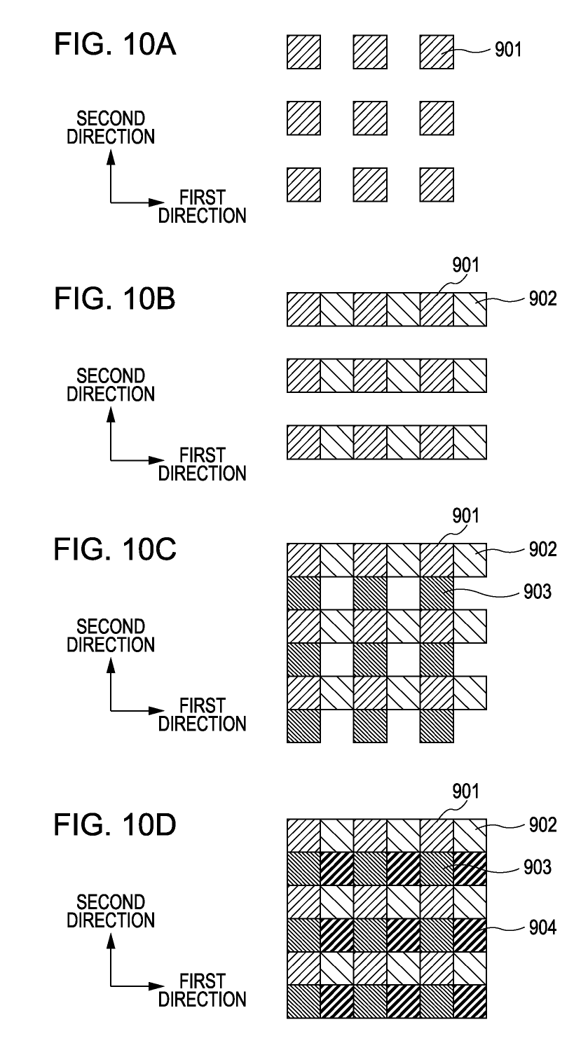

A method of conducting the substrate processing process four times is described with reference to FIGS. 10A to 10D. First, as shown in FIG. 10A, in the first substrate processing process, the pattern regions 901 are imprinted by adjusting the period of alignment of the pattern regions to be twice the pattern region width in both the first direction and the period of alignment in the second direction. Subsequently, the protective layer-forming step, the reverse pattern-forming step, and the substrate etching step are performed. For the purposes of this specification, “the period of alignment of the pattern regions” means the center-to-center distance of the patterns in the first or the second direction. In other words, in Example 2, the distance between the pattern regions formed in the first substrate processing process, in the first direction, is equal to the width of the pattern region in the first direction, and the space between the pattern regions formed in the second direction, orthogonal to the first direction, is equal to the width of the pattern region in the second direction.

Next, as shown in FIG. 10B, in the second substrate processing process, pattern regions 902 are formed between the pattern regions 901 adjacent in the first direction. Then, as shown in FIG. 10C, in the third substrate processing process, the pattern regions 903 are formed between the pattern regions 901 adjacent in the second direction. Lastly, as shown in FIG. 10D, in the fourth substrate processing process, pattern regions 904 are transferred onto the remaining regions. Note that the protective layer-forming step, the reverse pattern-forming step, and the substrate etching step are also conducted after each imprinting step.

According to the method of conducting the substrate processing process three times, the edges of the pattern regions remain unaligned in one of the first direction and the second direction. In contrast, according to the method of conducting the substrate processing process four times, the edges of the pattern regions are aligned in both the first and second directions. In other words, in the cases where the pattern regions are required to be aligned in both the first and second directions, the patterns can be transferred by connecting the patterns in the individual pattern regions.

### Example 3

In Example 3, the pattern regions are arranged differently from Examples 1 and 2. Since Example 3 differs from Examples 1 and 2 only in the arrangement of the pattern regions, only the arrangement the pattern regions is described below.

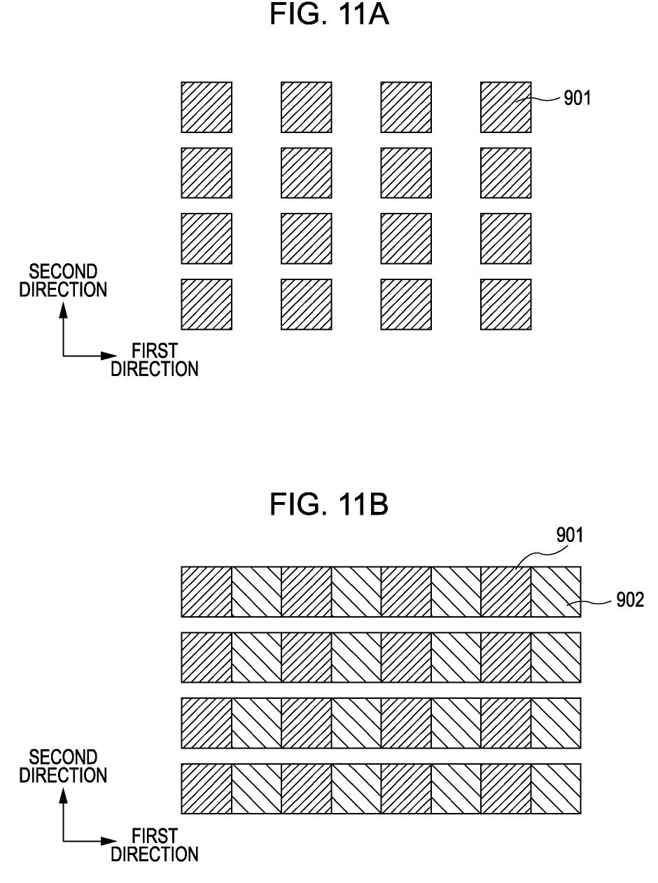

A method of conducting the substrate processing process twice is described with reference to FIGS. 11A and 11B. As shown in FIG. 11A, in the first substrate processing process, the patterns are transferred while setting the period of aligning the pattern regions 901 in the first direction to be twice the width of the pattern region and setting the distance between the pattern regions in the second direction orthogonal to the first direction to an appropriate value. Then, a protective layer-forming step and a substrate etching step are performed. Here, the “appropriate value” means a distance large enough to prevent a resin layer region from overlapping an adjacent resin layer region in the imprinting step. Next, in the second substrate processing process shown in FIG. 11B, patterns are transferred onto the regions between pattern regions in the first direction formed in the first substrate processing process, followed by a protective layer-forming step, a reverse pattern-forming step, and a substrate etching step.

According to the above-described steps of Example 3, patterns can be transferred onto the substrate by conducting the substrate processing process twice instead of three times, if the patterns of the pattern regions are to be connected in one direction only. The number of shots (imprinting) during the imprinting step, the arrangement of the pattern regions, the order of arrangement, and the shape of the pattern region of the mold are not limited to those described in the examples.

The present invention is not limited to the above embodiments, and various changes and modifications can be made within the spirit and scope of the present invention. Therefore, to apprise the public of the scope of the present invention, the following claims are made.

This application claims the benefit of Japanese Application No. 2007-334646 filed Month Dec. 26, 2007, which is hereby incorporated by reference herein in its entirety.

What is claimed is:

1. A method of processing a substrate, said method comprising:
(a) a step of providing a substrate having a first pattern formed on a portion of the substrate;
(b) a step of forming a resin layer at least on a portion of the substrate where the first pattern is not formed;
(c) a step of forming a pattern of a mold on a portion of the resin layer, the pattern being a second pattern, which includes protrusions and recesses;
(d) a step of forming a protective layer on the first pattern and at least the portion of the resin layer where the second pattern is formed;
(e) a step of etching the protective layer so that the protrusions of the second pattern are exposed and the protective layer in the recesses of the second pattern in the resin layer remains;
(f) a step of forming a reverse pattern, by etching the exposed protrusions of the pattern, to expose the substrate, while using the protective layer as a mask to prevent areas covered by the protective layer from being etched, so that the reverse pattern is formed on the protective layer having a structure reversed from the pattern imprinted on the portion of the resin layer; and
(g) a step of processing the exposed substrate, to process a desired pattern into the exposed substrate, while using the reverse pattern as a mask to prevent areas covered by the protective layer from being processed.

2. The method according to claim 1, wherein in said step of forming a protective layer, the protective layer is formed to satisfy the relationship:
H2>(R2/R1)×H1
where:
H1 is a depth of etching the substrate in said step of processing the exposed substrate;
H2 is a thickness of the protective layer on the substrate, at the final stage of said step for forming a reverse pattern;
R1 is an etching rate of the substrate in said step of processing the exposed substrate; and
R2 is an etching rate of the mask in said step of processing the substrate.

3. The method according to claim 1, wherein the second pattern formed on the portion of the resin layer is formed adjacent to the first pattern in one of (i) a first direction on a plane of the substrate and (ii) a second direction orthogonal to the first direction.

4. The method according to claim 1, wherein, in said step (c), a plurality of patterns are formed in a plurality of pattern regions.

5. The method according to claim 4, wherein steps (a) through (g) constitute a substrate processing process and the substrate processing process is conducted a plurality of times to process the substrate.

6. The method according to claim 5, wherein the substrate processing process is conducted three times,
in a first substrate processing process, the plurality of pattern regions are arranged in rows so that a space between the adjacent pattern regions in each row, in a first direction on a plane of the substrate, is twice the width of the pattern region in the first direction and a distance between a center of each adjacent row in a second direction, orthogonal to the first direction, is the width of the pattern region in the second direction, wherein the pattern regions in the second direction are arranged to not be in contact with each other,
in a second substrate processing process, the plurality of pattern regions are each arranged in regions adjacent to one side of the pattern regions formed in the first substrate processing process in the first direction, and
in a third substrate processing process, the plurality of pattern regions in which patterns are formed are each arranged in regions adjacent to the pattern regions formed in the second substrate processing process and adjacent to another side of the pattern regions formed in the first substrate processing process in the first direction.

7. The method according to claim 5, wherein the substrate processing process is conducted four times,
in a first substrate processing process, the plurality of pattern regions in which patterns are formed are arranged so that a space between the pattern regions, in a first direction on a plane of the substrate, is equal to the width of the pattern region in the first direction and a distance between the pattern regions in a second direction, orthogonal to the first direction, is equal to the width of the pattern region in the second direction,
in a second substrate processing process, the plurality of pattern regions are arranged in regions adjacent to the pattern regions formed in the first substrate processing process in the first direction,
in a third substrate processing process, the plurality of pattern regions are arranged in regions adjacent to the pattern regions formed in the first substrate processing process in the second direction, and
in a fourth substrate processing process, the plurality of pattern regions are arranged adjacent to the pattern regions formed in the second substrate processing process in the second direction.

8. The method according to claim 1, wherein the first pattern and the second pattern include an extended pattern for forming a first connecting region and a second connecting region, respectively, the first connecting region overlapping the second pattern and the second connecting region overlapping the first pattern.

9. The method according to claim 1, wherein an etching selectivity ratio of a material of the resin layer to a material of the protective layer is at least five.

10. A method of processing a substrate by imprinting, said method comprising:
(a) an applying step of applying a resin on at least a portion of the substrate to form a resin layer in a resin layer region;
(b) an imprinting step of imprinting a pattern of a mold onto a portion of the resin layer region, the pattern including protrusions and recesses;
(c) a protective layer forming step of forming a protective layer over (i) the resin layer region where the pattern is formed, (ii) the resin layer region where the pattern is not formed, and (iii) the substrate where the resin layer is not formed;
(d) a protective layer etching step of etching the protective layer so that (i) the protrusions of the pattern imprinted in the portion of the resin layer region are exposed and (ii) the protective layer in the recesses of the pattern in the portion of the resin layer region remains;
(e) a reverse pattern-forming step of etching the exposed protrusions of the pattern, to expose the substrate, while using the protective layer as a mask to prevent areas covered by the protective layer from being etched, so that a reverse pattern is formed on the protective layer, which has a structure reversed from the pattern imprinted on the portion of the resin layer region; and
(f) a substrate etching step of etching the exposed substrate, to etch a desired pattern in the exposed substrate, while using the reverse pattern as a mask to prevent areas covered by the protective layer from being etched,
wherein steps (a) through (f) constitute a substrate processing process and the substrate processing process is conducted a plurality of times to process the substrate.

11. The method according to claim 10, wherein in said imprinting step of a second and subsequent substrate processing processes, the resin layer region is formed on the substrate to at least partially overlap the resin layer region formed in a previous substrate processing process.

12. The method according to claim 10, wherein, in said protective layer forming step, the protective layer is formed to satisfy the relationship:
H2>(R2/R1)×H1
where:
H1 is a depth of etching the substrate in said substrate etching step;
H2 is a thickness of the protective layer on the substrate, at the final stage of said reverse pattern-forming step;
R1 is an etching rate of the substrate in said substrate etching step; and
R2 is an etching rate of the mask in said substrate etching step.

13. The method according to claim 10, wherein the substrate processing process is conducted twice, and the resin layer region in said applying step of a second substrate processing process and the resin layer region in said applying step of a first substrate processing process at least partially overlap each other in one of (i) a first direction on a plane of the substrate and (ii) a second direction orthogonal to the first direction.

14. The method according to claim 10, wherein, in said imprinting step, a plurality of patterns are formed in a plurality of pattern regions.

15. The method according to claim 14, wherein the substrate processing process is conducted three times,
in a first substrate processing process, the plurality of pattern regions are arranged in rows so that a space between the adjacent pattern regions in each row, in a first direction on a plane of the substrate, is twice the width of the pattern region in the first direction and a distance between a center of each adjacent row in a second direction, orthogonal to the first direction, is the width of the pattern region in the second direction, wherein the pattern regions in the second direction are arranged to not be in contact with each other,
in a second substrate processing process, the plurality of pattern regions are each arranged in regions adjacent to one side of the pattern regions formed in the first substrate processing process in the first direction, and
in a third substrate processing process, the plurality of pattern regions in which patterns are formed are each arranged in regions adjacent to the pattern regions formed in the second substrate processing process and adjacent to another side of the pattern regions formed in the first substrate processing process in the first direction.

16. The method according to claim 14, wherein the substrate is conducted four times,
in a first substrate processing process, the plurality of pattern regions in which patterns are formed are arranged so that a space between the pattern regions, in a first direction on a plane of the substrate, is equal to the width of the pattern region in the first direction and a distance between the pattern regions in a second direction, orthogonal to the first direction, is equal to the width of the pattern region in the second direction,
in a second substrate processing process, the plurality of pattern regions are arranged in regions adjacent to the pattern regions formed in the first substrate processing process in the first direction,
in a third substrate processing process, the plurality of pattern regions are arranged in regions adjacent to the pattern regions formed in the first substrate processing process in the second direction, and
in a fourth substrate processing process, the plurality of pattern regions are arranged adjacent to the pattern regions formed in the second substrate processing process in the second direction.

17. The method according to claim 10, wherein the pattern includes an extended pattern to form a connecting region so that the connecting region in a substrate processing process overlaps adjacent patterns from other substrate processing processes.

18. The method according to claim 10, wherein an etching selectivity ratio of a material of the resin layer to a material of the protective layer is at least five.
